(19) United States
(12) Patent Application Publication
(10) Pub. No.: US 2015/0182006 A1
(43) Pub. Date: Jul. 2, 2015

(54) SYSTEMS AND METHODS FOR DISPENSING LIPSTICK

(71) Applicant: Prov 31:31, LLC, Easton, CT (US)

(72) Inventor: Gina M. Blaze, Easton, CT (US)

(73) Assignee: PROV 31:31, LLC, Easton, CT (US)

(21) Appl. No.: 14/569,745

(22) Filed: Dec. 14, 2014

Related U.S. Application Data
(60) Provisional application No. 61/922,185, filed on Dec. 31, 2013.

(51) Int. Cl. A45D 44/00; G07F 9/02; G07F 13/06; A45D 40/00

(52) U.S. Cl. CPC A45D 44/005; A45D 40/00; G07F 9/023; G07F 13/06

(57) ABSTRACT

According to some embodiments, a system and a method of dispensing a lipstick container from an interactive vending machine located at a specific venue is presented. The lipstick container doubles as a container to store and dispense lipstick and as a souvenir by including a venue-specific logo upon an outer surface of the lipstick container.

### CROSS-REFERENCE TO RELATED APPLICATIONS

N/A

### FIELD

A method, machine and computer-readable medium for dispensing a lipstick container from an interactive vending machine located at a specific venue is generally described, the lipstick container doubling as a container to store and dispense lipstick and as a souvenir by including a venue-specific logo upon an outer surface thereof.

### BACKGROUND

Lipstick is a cosmetic product typically containing pigments, oils, waxes, and emollients that apply color, texture, moisture (balm), shine (gloss) and/or protection to the lips, including lip balm and/or lip gloss. Although the formulation used to create the lipstick may be made of man-made ingredients, it may also be made of all-natural ingredients.

Lipstick may function as a form of makeup or as a form of lip protection. Since lipsticks have multiple uses for a large variety of individuals, it would be desirable to provide systems and methods that facilitate a way to make lipsticks more available to the general public.

In particular, it seems inevitable that the lipstick is not available when it is most needed. For instance, when using a washroom, it is typical to gaze upon one's personal reflection in a mirror and to realize that a refreshing of the lipstick would improve one's personal appearance.

It is also understood that most people like to keep some memento of their travels, and typically purchase souvenirs to that end. Many venues include gift or souvenir shops for their customers to purchase such mementos, which typically include a venue-specific logo for the venue visited.

What is needed is a vending machine that can be strategically located to meet the needs of providing a lipstick container that doubles as a lipstick dispenser and a souvenir.

### BRIEF DESCRIPTION

According to an aspect, the present embodiments may be associated with a “user” who is seeking to purchase lipstick at a specific location. More specifically, the present embodiments relate to a method for dispensing a lipstick container from a vending machine located at a specific venue. The lipstick container doubles as (1) a container to store and dispense lipstick and (2) as a souvenir by including a venue-specific logo upon an outer surface of the lipstick container.

### BRIEF DESCRIPTION OF THE FIGURES

A more particular description will be rendered by reference to specific embodiments thereof that are illustrated in the appended drawings. Understanding that these drawings depict only typical embodiments and are not therefore to be considered to be limiting of its scope, exemplary embodiments will be described and explained with additional specificity and detail through the use of the accompanying drawings in which:

FIG. 1 is a flow chart that illustrates a method that may be performed according to an embodiment;

FIG. 2 is a block diagram representation of a vending machine that may be provided according to an embodiment;

FIG. 3 is a portion of a repository according to an embodiment;

FIG. 4 is a lipstick container according to an embodiment;

FIG. 5 is a display screen of a vending machine according to an embodiment; and

FIG. 6 is an illustrative example of a user purchasing a lipstick container including a venue-specific logo according to an embodiment.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to some embodiments.

### DETAILED DESCRIPTION

Reference will now be made in detail to embodiments. Each example is provided by way of explanation, and is not meant as a limitation and does not constitute a definition of all possible embodiments.

The term “pre-attached” may mean pre-attached, pre-affixed, pre-labeled/imprinted/engraved/embossed/emblazoned/stamped/etched or otherwise provided or placed upon an exterior surface of the lipstick container.

The term “container” may mean any container or receptacle or casing traditionally used to house or otherwise contain a lipstick including but not limited to a cylindrical or tubular assembly including a housing and a cap, and further including a mechanism for extending and retracting the lipstick from the assembly, or simply a tub and a lid.

The term “location” or “venue” may mean a bathroom, (otherwise known as a washroom, a restroom, or a powder room), an airport kiosk, an airport souvenir shop or store, a car dealership showroom, or an individual business location such as, but not limited to, a beauty salon, a gym, a sports complex or any business location.

The term “venue-specific logo” may mean the logo associated with either the specific venue or with the particular event occurring at that venue. For instance, if a national baseball team, e.g., the Chicago Cubs, are playing at a venue, e.g., Wrigley Field, the venue-specific logo would most likely be the logo associated with the team rather than the venue. As another example, if the artist Celine Dion is performing (i.e., the “event”) at a location or venue such as Caesars Palace in Las Vegas, the “venue-specific logo” may be either the logo for the artist or for Caesars Palace. In fact, it may be that a vending machine including the artist's logo is placed in close proximity to the theater within Caesars Palace where the artist is performing, while a vending machine including Caesars Palace's logo may be used within the casino itself.

The term “interactive” may mean of or relating to a two-way electronic communication between a user and a computer component such as a processor in which the computer component solicits information from the user and the user provides the solicited information to the computer component.

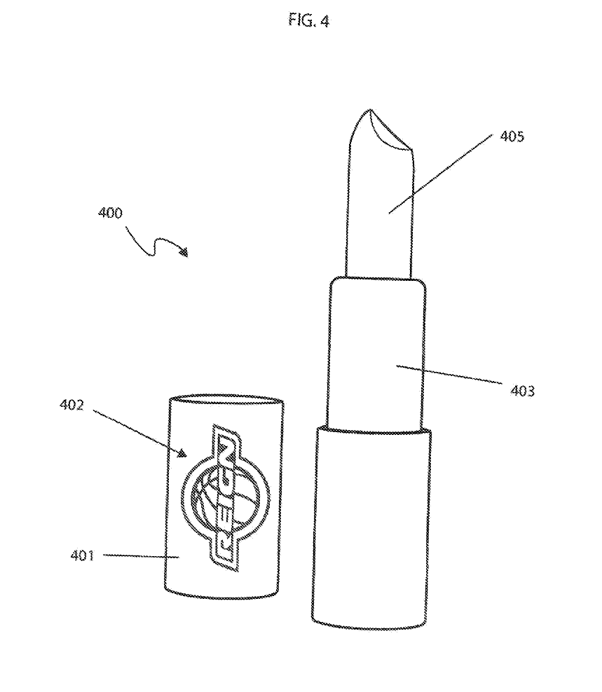

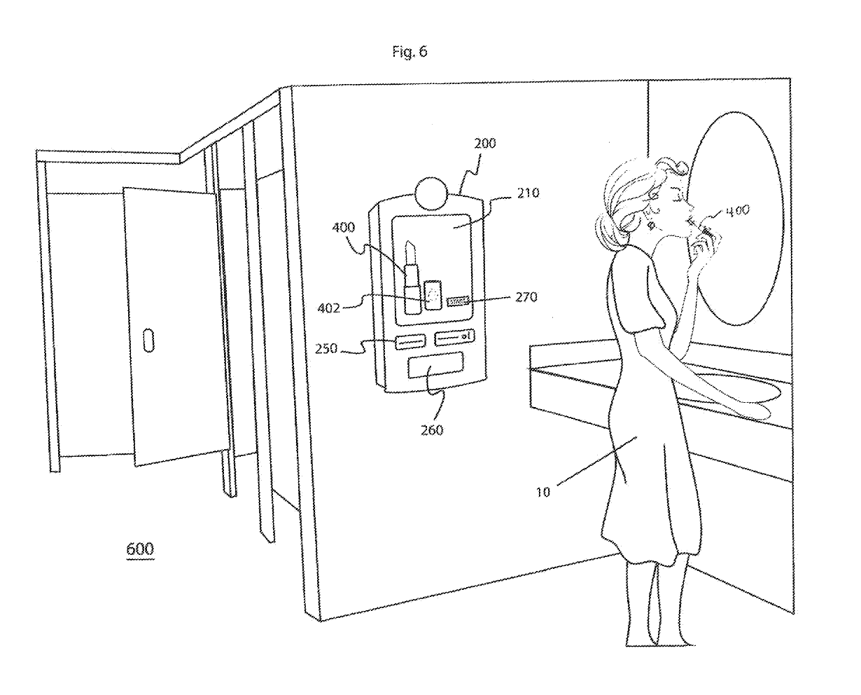

For purposes of illustrating features of the embodiments, a simple example will now be introduced and referenced throughout the disclosure. Those skilled in the art will recognize that this example is illustrative and not limiting and is provided purely for explanatory purposes. In the illustrative example and as seen in FIG. 6, a customer 10 (named “Jane Doe”) is attending a sporting event (e.g., a Washington Reign basketball game) at a specific location or venue (e.g., the Washington Arena). When Jane enters a restroom 600 and checks her appearance, she decides that she would like to purchase a lipstick 405 (see, for instance, FIG. 4) in a lipstick container 400. To that end, the specific venue, according to an aspect, has placed a vending machine 200 in the restroom 600 configured to dispense the lipstick container 400 that doubles as a lipstick dispenser and a souvenir by including a venue-specific logo 402 upon a surface of the lipstick container 400. In an embodiment, it is possible to dispense the lipstick container 400 in a suitably sized box (not shown). As shown in FIG. 4 and in an embodiment, the lipstick container 400 includes a lipstick dispenser 403, the lipstick 405, and a cap or cover 401, while the venue-specific logo 402 is pre-attached to an exterior surface of the container 400. As shown, the venue-specific logo 402 is attached to the cap 402 of the lipstick container 400.

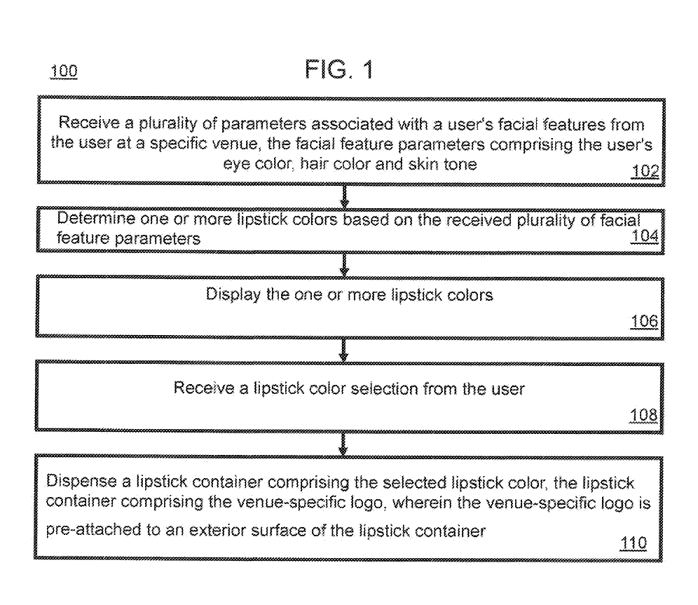

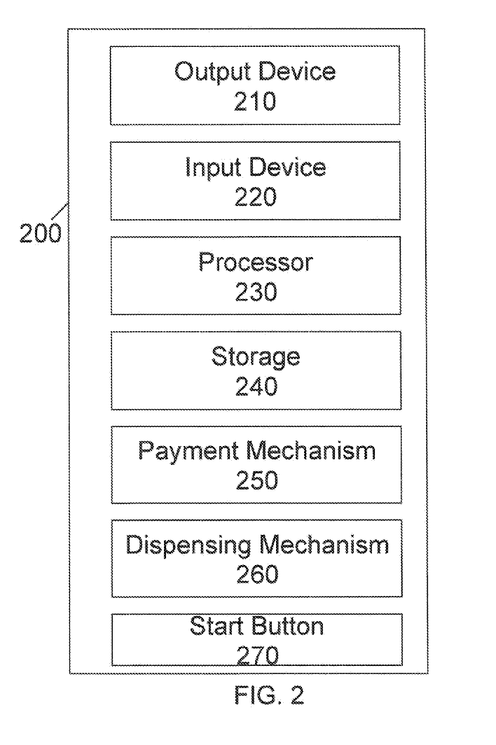

Turning now to FIG. 1, a flow chart is provided that illustrates a method 100 that may be performed according to some embodiments. The flow chart in FIG. 1 does not imply a fixed order to the steps, and the present embodiments can be practiced in any order that is practicable. Moreover, the methods may be performed by the vending machine 200 of FIG. 2. In an embodiment, the vending machine 200 is an interactive vending machine.

The method 100 of FIG. 1 may begin at 102, where a plurality of parameters associated with a user's facial features are received from the a user at a vending machine located at a specific venue. The facial feature parameters may include features associated with an appearance of the user's face and/or head, such as, but not limited to, the user's eye color, hair color and skin tone. In one embodiment, the facial feature parameters may be received via a user input where the user is provided a selection of predefined inputs for each facial feature parameter. In some embodiments, a digital camera may scan the user's face and/or head to determine the facial feature parameters.

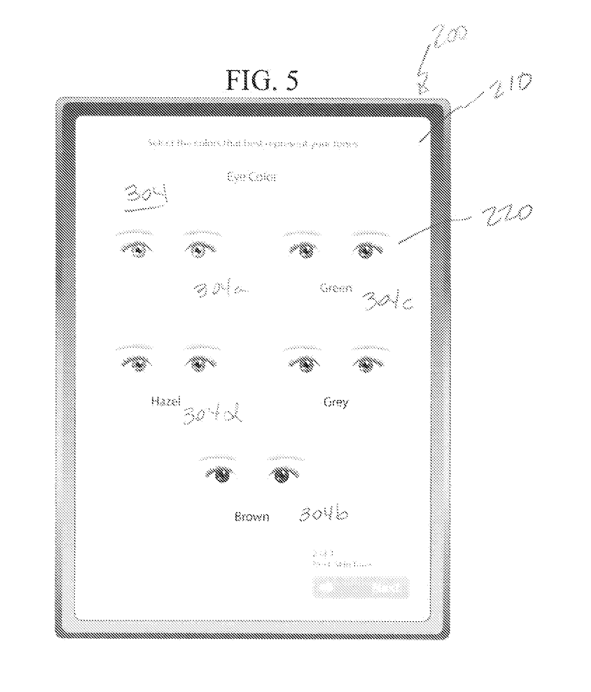

Referring to the illustrative example and FIGS. 2, 5 and 6, Jane Doe may initiate a purchase of the lipstick container 400 at the vending machine 200 by, e.g., inserting her credit card into a payment mechanism 250 of the vending machine 200 or by selecting a “start” button 270 positioned on a panel or displayed on a display screen 210, e.g., an interactive display screen using a touch screen such as an input device 220. In the illustrative example, Jane has blonde hair, blue eyes, and a tan complexion. The vending machine 200 may initiate a dialog with Jane, such as “Enter your eye color 304 from the following choices: A) Blue (304a), B) Brown (304b), C) Hazel (304d), or D) Green (304c)”. Since Jane has blue eyes, she may select “A” (e.g., Blue—304a) by touching the display screen 210 at the Blue eye position 304b. Similar dialogs may be used to enter Jane's hair color (e.g., blonde) and skin tone/color (e.g., tan) (not shown).

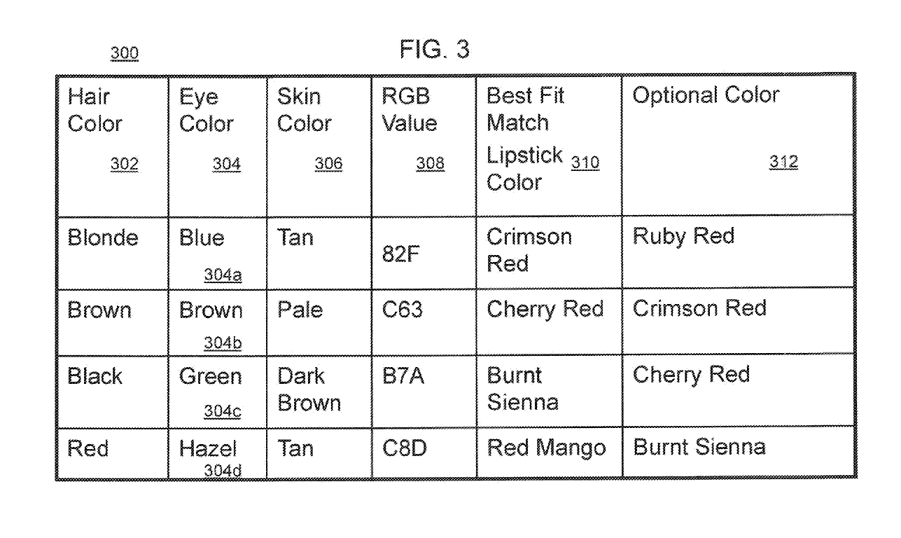

At 104, one or more lipstick colors may be determined based on the received plurality of facial feature parameters. The determination may be made by a processor, such as the processor 230 described with respect to FIG. 2. The determination may be made by a lookup table to determine a best-fit match lipstick color from a combination of colors. For example, and now referring to FIG. 3, a portion of a lipstick lookup table 300 that may be stored at the vending machine 200 is illustrated according to an embodiment. The lipstick lookup table 300 may be part of a repository such as, but not limited to a database or a flat-file database in which each database is contained in a single table or in a relational database system in which multiple tables are used to store information, and each table can have a different record format. Furthermore, the lipstick lookup table 300 may include entries related to colors of user/customer facial features as well as colors of lipsticks. The lipstick lookup table 300 may define fields 302, 304, 306, 308, 310, 312 and fields for each of the entries. The fields may typically specify: hair color 302; eye color 304; skin color 306; Red Green Blue (“RGB”) value 308; best lipstick color 310; and an optional lipstick color 312.

Referring to the illustrative example, a look up of Jane's input parameters (e.g., blonde hair, blue eyes, and tan skin tone) in the lipstick lookup table 300 may produce a best-fit match lipstick color of crimson red. In some embodiments multiple choices may be presented to the user such as a best choice of crimson red and a secondary or optional choice of ruby red. In this manner, a user may be presented with a best-fit matched color as well as an optional choice.

In some embodiments, each color associated with a facial feature parameter may be converted to a red, green, blue color code (e.g., a RGB color code or other computer based color coding such as HTML color codes). The vending machine 200, via the processor 230, may use a formula to combine the RGB colors 308 for each facial feature parameter (e.g., average, or summed) and then look up the combined RGB color in a lookup table such as 308 in lipstick lookup table 300. In some embodiments, different facial feature parameter colors may be weighted higher or lower. For example, a skin tone 306 may be considered more important than a hair color 302 and thus a skin tone color 306 may be assigned a multiplier (e.g., 1.5) while a hair color 302 may receive no multiplier value. Furthermore, in some embodiments, the vending machine 200 may change the multiplier value based on a time of day such as a weighing the combination to produce a lighter shade during the day and a darker shade at night. In this way, multiple color choices may be presented based on different multiplier values.

Referring back to FIG. 1, at 106, the one or more lipstick colors are displayed. Referring to the illustrative example, Jane Doe is presented with one or more choices of lipstick color based on the colors complimentary to and associated with her facial feature parameters. In the present example, Jane is presented with both crimson red and ruby red as her color selections. In an embodiment, Jane may be presented with both a name and a color image of the lipstick.

At 108, a lipstick color selection is received from the user. For example, and again referring to the illustrative example, Jane, in response to the selection of lipstick colors presented to her, chooses the best fit match crimson red lipstick color. In an alternative embodiment, Jane selects the option or alternative lipstick color ruby red. In yet another embodiment, Jane selects a lipstick color of her own choice.

At 110, the lipstick container comprising the selected lipstick color is dispensed. The lipstick container may comprise a venue-specific logo, wherein the venue-specific logo is pre-attached to an exterior surface of the lipstick container. For example, and now referring to FIG. 4, an embodiment of a lipstick container 400 is illustrated. As illustrated in FIG. 4, the lipstick container comprises a venue-specific logo 402. The venue-specific logo 402 may be pre-attached, pre-affixed, pre-labeled, imprinted, engraved, embossed, emblazoned, stamped, etched or otherwise provided or placed upon an exterior surface of the lipstick container 400.

Referring again to the illustrative example, Jane receives a lipstick container comprising the ruby red lipstick with the logo for the Washington Reign attached to the outer surface of the lipstick container. As stated previously, Jane is currently attending a Washington Reign's basketball game at the Washington Arena and thus her lipstick container further serves as a souvenir for the basketball game. In an alternative embodiment, the lipstick container contains a logo for the Washington Arena, rather than the basketball team logo. In yet another embodiment, both logos are displayed and pre-attached to the lipstick container.

According to some embodiments, FIG. 2 is a block diagram of a vending machine 200. The vending machine 200 may comprise a processor 230 that includes or is otherwise associated with dedicated registers, stacks, queues, etc. that are used to execute program code and/or one or more of these elements may be shared therebetween. In some embodiments, the processor 230 may comprise an integrated circuit. In some embodiments, the processor 230 may comprise circuitry to perform a method such as, but not limited to, the method described with respect to FIG. 1.

The vending machine 200 may further include a payment mechanism 250 that may receive credit cards and/or local currency. Furthermore, the payment mechanism 250 may initiate a purchase upon receiving payment. In an embodiment, insertion of a credit card into the payment mechanism 250 initiates the interactive aspects of lipstick selection. The vending machine 200 may also include a local input device 220 to receive data. The local input device 220 may comprise, for example, a keyboard, a mouse or other pointing device, a switch, an infrared port, a camera and/or a touch screen that is in communication with the processor 230. Such a local input device 220 may be used, for example, to receive facial feature input parameters, user selections and information associated with payment of a lipstick container. The processor 230 may also be in communication with a local output device 210. The local output device 210 may comprise, for example, a display (e.g., the touch screen), a speaker, and/or a printer. The local output device 210 may be used, for example, to present options and/or payment information to the user. In some embodiments, the output device 210 may display (e.g., a display screen) on an external surface of the vending machine at least one of the venue-specific logo (e.g., a logo of a sports team associated with a present location of the vending machine), advertising messages, advertising graphics, and upcoming events.

The storage device 240 may comprise a non-transitory computer-readable medium to store a program for controlling the processor 230. The program may be stored in a compressed, uncompiled and/or encrypted format. The program may furthermore include other program elements, such as an operating system, a database management system, and/or device drivers used by the processor 230 to interface with peripheral devices.

The processor 230 may perform instructions of the program, and thereby operates in accordance with the present embodiments. For example, the processor 230 may receive colors associated with facial feature parameters of a user, and then use that data to determine a best-fit match lipstick color for the user (and possible optional colors), and then present the colors to the user. The vending machine 200 may also comprise a dispenser 260 that is configured to dispense a lipstick container associated with a selected lipstick color.

The components and methods illustrated are not limited to the specific embodiments described herein, but rather, features illustrated or described as part of one embodiment can be used on or in conjunction with other embodiments to yield yet a further embodiment. It is intended that the method, machine and computer-readable medium described herein include such modifications and variations. Further, steps described in the method may be utilized independently and separately from other steps described herein.

While the method, machine and computer-readable medium described herein have been described with reference to a preferred embodiment, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment”, “some embodiments”, “an embodiment” and the like are not intended to be interpreted as excluding the existence of additional embodiments that also incorporate the recited features.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.”

Advances in science and technology may make equivalents and substitutions possible that are not now contemplated by reason of the imprecision of language; these variations should be covered by the appended claims. This written description uses examples to disclose the method, machine and computer-readable medium described herein, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method for dispensing a lipstick container from an interactive vending machine located at a specific venue, the lipstick container doubling as a container to store and dispense lipstick and as a souvenir by including a venue-specific logo upon an outer surface thereof, the method comprising:
receiving a plurality of parameters associated with a user's facial features from the user at a specific venue, the facial feature parameters comprising the user's eye color, hair color and skin tone;
determining, via a processor, one or more lipstick colors based on the received plurality of parameters;
displaying the one or more lipstick colors;
receiving a lipstick color selection from the user; and
dispensing a lipstick container comprising the selected lipstick color, the lipstick container comprising the venue-specific logo, wherein the venue-specific logo is pre-attached to an exterior surface of the lipstick container.

2. The method of claim 1, wherein the specific venue is selected from the group consisting of a bathroom, airport kiosk, airport store, car dealership showroom, an individual business location, a beauty salon, a gym, or a sports complex.

3. The method of claim 1, further comprising:
displaying on a display screen on an external surface of the vending machine at least one of the venue-specific logo, advertising messages, advertising graphics, and upcoming events.

4. The method of claim 1, wherein determining comprising an automatic generation of a best fit match of the lipstick color based on the received plurality of parameters.

5. The method of claim 1, wherein determining the one or more lipstick colors based on the received plurality of parameters comprises:
determining a weighted average of RGB values for the user's eye color, hair color and skin tone; and
looking up the weighted average in a repository to determine the one or more lipstick colors.

6. The method of claim 1, wherein determining the one or more lipstick colors based on the received plurality of parameters comprises:
looking up a combination of the plurality of parameters associated with the user's eye color, hair color and skin tone in a database to determine the one or more lipstick colors.

7. An interactive vending machine located at a specific venue to dispense a lipstick container comprising a venue-specific logo, the vending machine comprising:
a processor; and the processor configured to:
receive a plurality of parameters associated with a user's facial features from the user at a specific venue, the facial feature parameters comprising the user's eye color, hair color and skin tone; and
determine one or more lipstick colors based on the received plurality of parameters;
an interactive display screen configured to display the one or more lipstick colors;
the processor further configured to receive a lipstick color selection from the user; and
a dispenser configured to dispense a lipstick container comprising the selected lipstick color, the lipstick container comprising a venue-specific logo based on the specific venue, wherein the venue-specific logo is pre-attached to an exterior surface of the lipstick container.

8. The vending machine of claim 7, wherein the specific venue is selected from the group consisting of a bathroom, airport kiosk, airport store, car dealership showroom, an individual business location, a beauty salon, a gym, or a sports complex.

9. The vending machine of claim 7, wherein the display screen is positioned on an external surface of the vending machine and is further configured to display at least one of the venue-specific logo, advertising messages, advertising graphics, and upcoming events.

10. The vending machine of claim 7, wherein determining comprising an automatic generation of a best fit match of the lipstick color based on the received plurality of parameters.

11. The vending machine of claim 7, wherein determining the one or more lipstick colors based on the received plurality of parameters comprises:
determining a weighted average of RGB values for the user's eye color, hair color and skin tone; and
looking up the weighted average in a database to determine the one or more lipstick colors.

12. The vending machine of claim 7, wherein determining the one or more lipstick colors based on the received facial feature parameters comprises:
looking up a combination of the plurality of parameters associated with the user's eye color, hair color and skin tone in a database to determine the one or more lipstick colors.

13. The vending machine of claim 7, further comprising:
a plurality of lipstick containers comprising the venue-specific logo;

14. A non-transitory computer-readable medium comprising instructions that when executed by a processor perform a method for dispensing a lipstick container from an interactive vending machine located at a specific venue, the lipstick container doubling as a container to store and dispense lipstick and as a souvenir by including a venue-specific logo upon an outer surface thereof, the method comprising:
receiving a plurality of parameters associated with a user's facial features from the user at a specific venue, the facial feature parameters comprising the user's eye color, hair color and skin tone;
determining, via a processor, one or more lipstick colors based on the received plurality of parameters;
displaying the one or more lipstick colors;
receiving, a lipstick color selection from the user; and
dispensing a lipstick container comprising the selected lipstick color, the lipstick container comprising the venue-specific logo, wherein the venue-specific logo is pre-attached to an exterior surface of the lipstick container.

15. The medium of claim 14, wherein the specific venue is selected from the group consisting of a bathroom, airport kiosk, airport store, car dealership showroom, an individual business location, a beauty salon, a gym, or a sports complex

16. The medium of claim 14, the method further comprising displaying on a display screen on an external surface of the vending machine at least one of the venue-specific logo, advertising messages, advertising graphics, and upcoming events.

17. The medium of claim 14, wherein determining comprising an automatic generation of a best fit match of the lipstick color based on the received plurality of parameters.

18. The medium of claim 14, wherein determining the one or more lipstick colors based on the received plurality of parameters comprises:
determining a weighted average of RGB values for the user's eye color, hair color and skin tone; and
looking up the weighted average in a database to determine the one or more lipstick colors.

19. The medium of claim 14, wherein determining the one or more lipstick colors based on the received plurality of parameters comprises:
looking up a combination of the plurality of parameters associated with the user's eye color, hair color and skin tone in a database to determine the one or more lipstick colors.
